(19) United States
(12) Patent Application Publication
(10) Pub. No.: US 2010/0225873 A1
(43) Pub. Date: Sep. 9, 2010

(54) LIQUID CRYSTAL DISPLAY DEVICE

(76) Inventor: Koji TAKAHASHI, Ishikawa-gun (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/715,724

(22) Filed: Mar. 2, 2010

(30) Foreign Application Priority Data
Mar. 3, 2009 (JP) 2009049604
Feb. 25, 2010 (JP) 2010040493

(51) Int. Cl. G02F 1/1339

(52) U.S. Cl. 349/155

(57) ABSTRACT

A liquid crystal display device include a pair of substrates opposed to each other, a liquid crystal layer held between the pair of substrates, a display section including a plurality of matrix-arrayed display pixels, a sealant disposed between the substrates to surround the display section, and a plurality of spacers disposed in a region where the sealant is disposed. A density of disposition of the spacers having such a value as to set a thickness of the sealant between the spacers and one of the substrates at a predetermined value.

### CROSS-REFERENCE TO RELATED APPLICATIONS

This application is based upon and claims the benefit of priority from prior Japanese Patent Applications No. 2009-049604, filed Mar. 3, 2009; and No. 2010-040493, filed Feb. 25, 2010, the entire contents of both of which are incorporated herein by reference.

### BACKGROUND OF THE INVENTION

1. Field of the Invention

The present invention relates generally to a liquid crystal display device, and more particular to an active matrix liquid crystal display device.

2. Description of the Related Art

A liquid crystal display device includes a liquid crystal display panel which generally comprises an array substrate, a counter-substrate which is disposed to be opposed to the array substrate, and a liquid crystal layer which is held between the array substrate and the counter-substrate.

It is known that if non-uniformity occurs in the distance between the array substrate and the counter-substrate, the display quality of the liquid crystal device deteriorates. Specifically, it is known that the light transmittance varies due to a variation in Δn·d value (An: birefringence index of liquid crystal, d: thickness of liquid crystal layer). If the distribution of the Δn·d value (distribution of liquid crystal layer thickness d) is large, a distribution occurs in light transmittance, leading to a decrease in contrast and non-uniformity of a display image.

In order to make the distance between the substrates uniform in the plane of the substrates, there is known a technique wherein spacers, which are formed of granular bodies such as resin balls or glass balls, or spacers which are formed of columnar bodies of a resin, are disposed between the paired substrates.

In general, since spherical spacers of, e.g. resin balls or glass balls are scattered on the substrate by a wet method, it is difficult to control the positions or the density of disposition of such spherical spacers. Columnar spacers can be formed, for example, by forming a resin film on the substrate and then patterning the resin film. Thus, the columnar spacers are advantageous in that the positions or density of disposition can easily be controlled.

Conventionally, there has been proposed a liquid crystal display device which is manufactured by a dispenser method, wherein the number density of columnar spacers is lower in a low-density region in the vicinity of the inside of a sealant than in a high-density region which is located more inward of the low-density region (see WO2005/038518).

However, the inventor of the present application has found that if attention is paid to the distribution density of columnar spacers in the region where the sealant is disposed, the sealant bites in over the columnar spacers in the region where the sealant is disposed, the amount of bite of the sealant varies depending on the density of disposition of the columnar spacers, and non-uniformity in display occurs due to the thickness of the sealant over the spacers.

If the density of disposition of columnar spacers is set to be equal between a display section and a peripheral section 120 surrounding the display section, the thickness of the sealant on the spacers decreases, for example, in the case where the density of disposition of columnar spacers disposed in the display section is low. In this case, the cell gap of the peripheral section 120 decreases, and there easily occurs non-uniformity in gap in a rebound mode, or non-uniformity in gap in the vicinity of the center of the screen.

On the other hand, if the density of disposition of columnar spacers is made equal between the display section and the peripheral section 120, the thickness of the sealant on the spacers increases, for example, in the case where the density of disposition of columnar spacers disposed in the display section is high. In this case, the cell gap of the peripheral section 120 increases, and there easily occurs non-uniformity in gap in the periphery.

### BRIEF SUMMARY OF THE INVENTION

According to an embodiment of the present invention, there is provided a liquid crystal display device comprising: a pair of substrates opposed to each other; a liquid crystal layer held between the pair of substrates; a display section including a plurality of matrix-arrayed display pixels; a sealant disposed between the substrates to surround the display section; and a plurality of spacers disposed in a region where the sealant is disposed, a density of disposition of the spacers having such a value as to set a thickness of the sealant between the spacers and one of the substrates at a predetermined value.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows a structure example of a liquid crystal display device according to an embodiment of the present invention;

FIG. 2 schematically shows an example of a cross-sectional structure in the vicinity of a region where a sealant of the liquid crystal display device shown in FIG. 1 is disposed;

FIG. 3 is a view for explaining an example of the relationship between a substrate lift amount and a gap non-uniformity occurrence ratio;

FIG. 4 is a view for explaining an example of the relationship between the density of disposition of second spacers and the thickness of the sealant on the second spacers;

FIG. 5 is a view for explaining an example of the substrate lift amount of the liquid crystal display device according to the embodiment of the invention; and

FIG. 6 is a table for explaining an example of an evaluation result in connection with the density of disposition of second spacers.

### DETAILED DESCRIPTION OF THE INVENTION

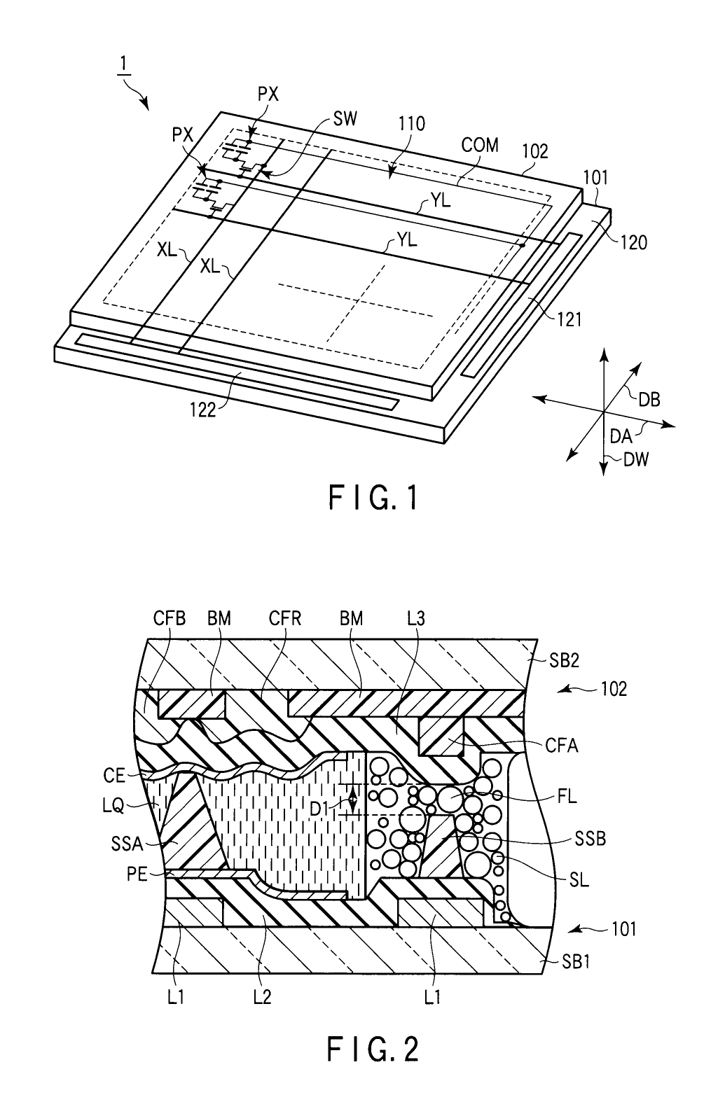

A liquid crystal display device according to an embodiment of the present invention will now be described with reference to the accompanying drawings. The liquid crystal display device according to the embodiment is a liquid crystal display device which is fabricated by a dispenser method. As shown in FIG. 1, the liquid crystal display device 1 comprises an array substrate 101 and a counter-substrate 102 which are disposed to be opposed to each other, a liquid crystal layer LQ (shown in FIG. 2) which is held between the array substrate 101 and counter-substrate 102, and a display section 110 comprising a plurality of matrix-arrayed display pixels PX.

The array substrate 101 comprises, in the display section 110, pixel electrodes PE disposed in association with the respective display pixels PX, a plurality of scanning lines YL extending along rows of the plural display pixels PX, a plurality of signal lines XL extending along columns of the plural display pixels PX, and pixel switches SW disposed near intersections between the scanning lines YL and signal lines XL.

The gate electrode (not shown) of the pixel switch SW is connected to the associated scanning line YL, or is formed integral with the associated scanning line YL. The source electrode (not shown) of the pixel switch SW is connected to the associated signal line XL, or is formed integral with the associated signal line XL. The drain electrode (not shown) of the pixel switch SW is connected to the associated pixel electrode PE.

The array substrate 101 includes a storage capacitance line COM extending substantially in parallel to the scanning line YL. The storage capacitance line COM is disposed in a manner to overlap a portion of the pixel electrode PE via an insulation layer, and constitutes a storage capacitance Cs by a potential difference between the storage capacitance line COM and the pixel electrode PE.

A scanning line driving circuit 121, to which the plural scanning lines YL are connected, and a signal line driving circuit 122, to which the plural signal lines XL are connected, are disposed in a peripheral section 120 which surrounds the display section 110. The scanning line driving circuit 121 successively drives the scanning lines YL, thereby rendering conductive the source-drain path of each of the associated pixel switches SW. The signal line driving circuit 122 successively drives the signal lines XL, thereby applying a source voltage to each of the associated pixel electrodes PE via the associated pixel switches SW.

The counter-substrate 102 includes a light-blocking layer BM which is disposed in a manner to surround the display pixel PX, and a counter-electrode CE which is disposed to be opposed to the plural pixel electrodes PE. As shown in FIG. 2, the light-blocking layer BM is disposed between the display pixels PX and also disposed in the peripheral section 120 surrounding the display section 110.

A counter-voltage is applied to the counter-electrode CE by a counter-electrode driving circuit (not shown). The alignment state of liquid crystal molecules (not shown) included in the liquid crystal layer LQ is controlled by a potential difference between the source voltage which is applied to the pixel electrode PE and the counter-voltage which is applied to the counter-electrode CE.

In the case of the liquid crystal display device of a color display type, the counter-substrate 102 includes a color filter layer and an overcoat layer L3 which is disposed on the color filter layer. The color filter layer comprises, for example, a red color filter CFR which corresponds to the display pixel PX for displaying red and passes light with a major wavelength of red, a green color filter (not shown) which corresponds to the display pixel PX for displaying green and passes light with a major wavelength of green, and a blue color filter CFB which corresponds to the display pixel PX for displaying blue and passes light with a major wavelength of blue.

The array substrate 101 and counter-substrate 102 are fixed with a predetermined gap by a sealant SL which is disposed in the peripheral section 120 in a manner to surround the display section 110. The sealant SL includes a filler FL, as shown in FIG. 2. Spacers SS are disposed for defining the gap between the array substrate 101 and counter-substrate 102.

As shown in FIG. 2, the spacers SS of the liquid crystal display device according to the embodiment are columnar spacers. The spacers SS are disposed to be opposed to the light-blocking layer BM of the counter-substrate 102 in the thickness direction of the liquid crystal display panel. The array substrate 101 includes a base-seat layer L1 which becomes an underlayer of the spacers SS, and an insulation layer L2 which is disposed over the base-seat layer L1. The pixel electrode PE is disposed on the insulation layer L2.

The spacers SS include a first spacer SSA which is disposed in the display section 110, and a second spacer SSB which is disposed in the region where the sealant SL is disposed. At the position opposed to the second spacer SSB, a base-seat layer, which becomes a base seat of the second spacer SSB, is disposed on the light-blocking layer BM of the counter-substrate 102. The base-seat layer CFA is formed of, for example, the same material as the blue color filter CFB. An overcoat layer L3 is disposed on the color filter layer and the base-seat layer CFA.

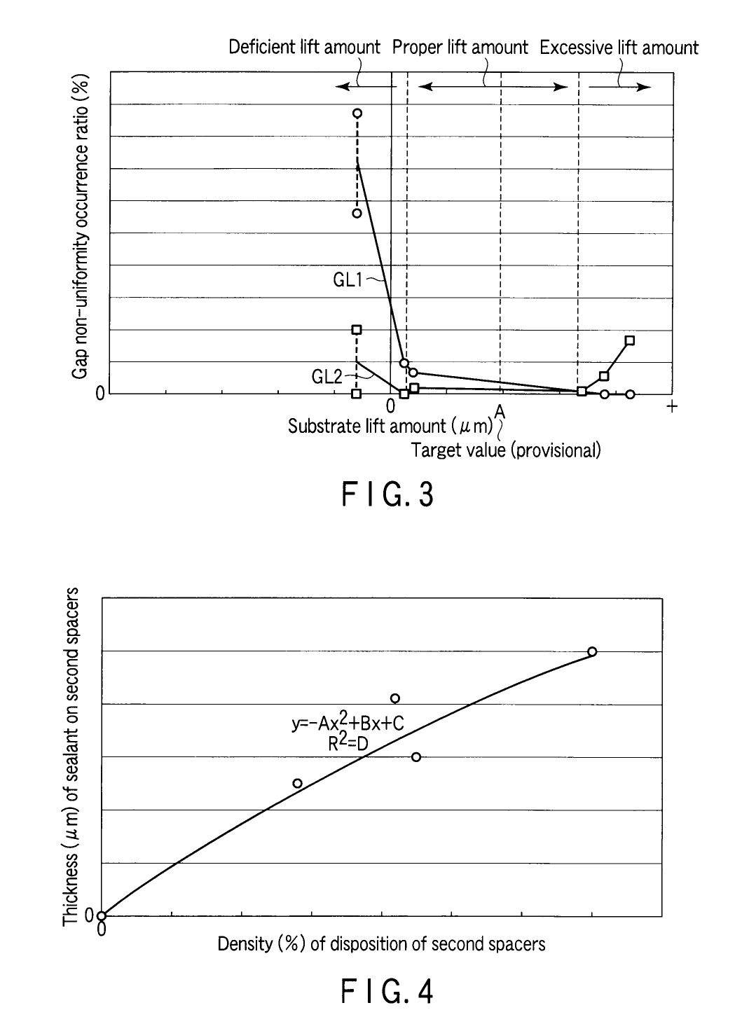

FIG. 3 shows the ratio of the display gap occurrence in relation to a lift amount W of the substrate in the peripheral section 120 of the liquid crystal display panel. A graph GL1 in FIG. 3 indicates the probability of occurrence of white gap non-uniformity (gravitation non-uniformity), which occurs due to the influence of gravitation, in the central part of the liquid crystal display panel. A graph GL2 in FIG. 3 indicates the probability of occurrence of peripheral gap non-uniformity, which occurs in a case where the gap between the array substrate 101 and counter-substrate 102 is not a desired value, in the vicinity of the end part of the display section 110 of the liquid crystal display panel (i.e. in the vicinity of the sealant SL).

The substrate lift amount W in the peripheral section 120 is a distance in a thickness direction DW of the liquid crystal display panel between the central part of the array substrate 101 or counter-substrate 102 and that part of the array substrate 101 or counter-substrate 102, which is supported by the sealant SL, in a direction substantially parallel to the substrate plane (DA-DB plane).

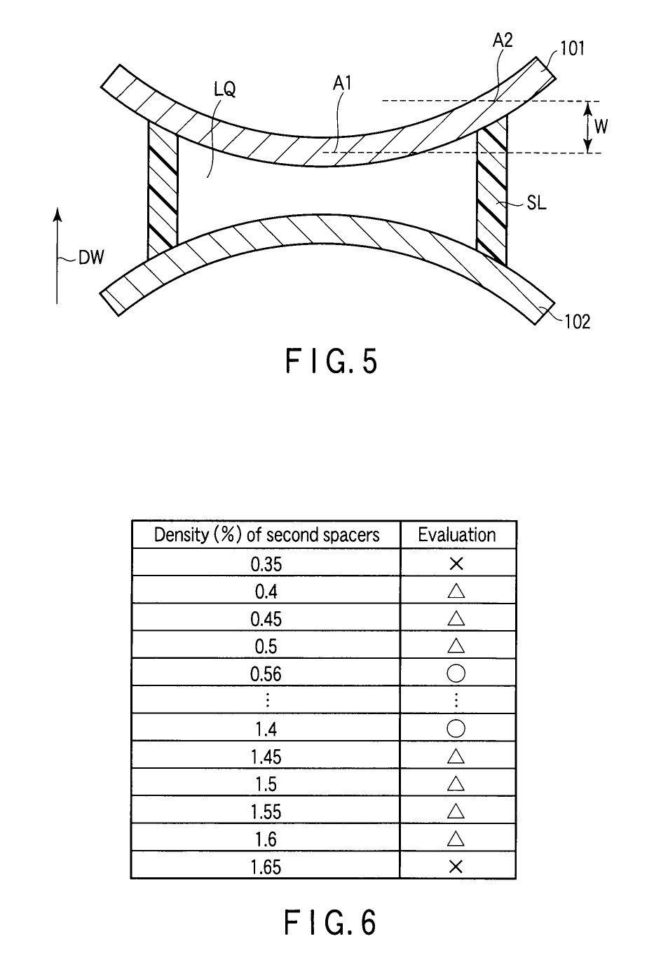

In the case shown in FIG. 5, the substrate lift amount W is a distance in the direction DW between a central part A1 of the array substrate 101, where the gap between the array substrate 101 and counter-substrate 102 is minimum, and a part A2 of the array substrate 101, which is supported by the sealant SL. In the case shown in FIG. 5, each of the central part A1 and peripheral part A2 is set at a substantially central position of the array substrate 101 in the thickness direction DW of the liquid crystal display panel.

As shown in FIG. 3, if the substrate lift amount W of the liquid crystal display panel is deficient, the probability of occurrence of white gap non-uniformity in the central part of the display section 110 increases, and also the probability of occurrence of peripheral gap non-uniformity increases. If the substrate lift amount W in the peripheral section 120 is excessive, the probability of occurrence of peripheral gap non-uniformity increases.

The substrate lift amount W in the peripheral section 120 is controlled by the thickness of the base-seat layer CFA, the thickness D1 of the sealant SL on the second spacer SSB, and the thickness of the base-seat layer L1. In the process of fabricating these parts, it is difficult to control the thickness of the base-seat layer CFA. The thickness D1 is a thickness of the sealant SL between the second spacer SSB and one of pair of substrates 101, 102.

In consideration of the above circumstance, the inventor of the present application paid attention to the thickness of the sealant SL on the second spacer SSB, and found that the thickness of the sealant SL on the second spacer SSB can be controlled by the density of disposition of second spacers SSB in the region where the sealant SL is disposed.

The density of disposition of second spacers (spacer-in-sealant density) is the ratio (%) of the area of the region, where the second spacers are disposed, to the area of the region of the array substrate 101 or counter-substrate 102, where the sealant SL is disposed, in the state in which the array substrate 101 and counter-substrate 102 are opposed and attached.

The inventor measured the density (%) of disposition of second spacers SSB and the thickness (μm) of the sealant SL that is disposed on the second spacers SSB, and found that there is a relationship as shown in FIG. 4 between the density (%) of disposition of second spacers SSB and the thickness D1 of the sealant SL that is disposed on the second spacers SSB.

FIG. 4 shows an example of the measurement result of the thickness (μm) of the sealant on the second spacers SSB, with respect to four liquid crystal display devices having different densities (%) of disposition of second spacers SSB.

As shown in FIG. 4, there is a tendency that if the density (%) of disposition of second spacers SSB increases, the thickness of the sealant SL that is disposed on the second spacers SSB also increases. The thickness (y) of the sealant SL that is disposed on the second spacers SSB can be approximated by a quadratic equation (y=Ax²+Bx+C) of the density (x) of second spacers SSB.

In the meantime, the quadratic function shown in FIG. 4 was an example derived from a general polynomial approximation method (second order).

For example, if the target value of the substrate lift amount W of the peripheral section 120 is set at A (μm), the lift amount due to the thickness of the base-seat layer CFA and the thickness of the base-seat layer L1 is subtracted from this target value, and it is thus possible to calculate the thickness D1 of the sealant SL on the second spacers SSB in the case where the substrate lift amount W becomes the target value A (μm). Hence, it is possible to derive the density of disposition of second spacers SSB, which corresponds to the thickness D1 of the sealant SL calculated by the quadratic function shown in FIG. 4. In the liquid crystal display device according to the embodiment, the target value A of the substrate lift amount W was set at about 0.4 μm.

If the second spacers SSB are disposed with the density that is derived as described above, and the liquid crystal display panel is fabricated, the substrate lift amount W in the peripheral section 120 can be set at the target value A (μm) and the liquid crystal display device with a low ratio of occurrence of display non-uniformity can be manufactured.

Preferably, the target value A (μm) of the substrate lift amount W in the peripheral section 120 should be set in a range of between about 0 μm and about 0.8 μm. As shown in FIG. 3, in the case where the substrate lift amount in the peripheral section is out of the range of between about 0 μm and about 0.8 μm, such a tendency is observed that the ratio of occurrence of white gap non-uniformity and peripheral gap non-uniformity sharply increases.

FIG. 6 shows an example of the evaluation result in the case where the density of disposition of second spacers SSB was more than or equal to 0.35% and smaller than or equal to 1.65%. In the evaluation result shown in FIG. 6, “×” indicates the case in which the ratio of occurrence of display non-uniformity was high, “Δ” indicates the case in which the ratio of occurrence of display non-uniformity was low and a good display quality was obtained, and “◯” indicates the case in which no display non-uniformity was visually observed and a good display quality was obtained.

As shown in FIG. 6, when the density of disposition of second spacers SSB was 0.35% and when the density of disposition of second spacers SSB was 1.65%, the ratio of occurrence of display non-uniformity was high and a liquid crystal display device with a good display quality was not obtained (evaluation “×”). When the density of disposition of second spacers SSB was more than or equal to 0.4% and smaller than or equal to 0.5% and when the density of disposition of second spacers SSB was more than or equal to 1.45% and smaller than or equal to 1.6%, the ratio of occurrence of display non-uniformity was low and a liquid crystal display device with a good display quality was obtained (evaluation “Δ”). When the density of disposition of second spacers SSB was more than or equal to 0.56% and smaller than or equal to 1.4%, no display non-uniformity was observed and a liquid crystal display device with a good display quality was obtained (evaluation “◯”).

From the above-described evaluation result, the liquid crystal display device with a good display quality was obtained by setting the density of disposition of second spacers SSB more than or equal to 0.4% and smaller than or equal to 1.6%, preferably more than or equal to 0.56% and smaller than or equal to 1.4%.

Thus, according to the present embodiment, there can be obtained a liquid crystal display device which optimizes the density of disposition of columnar spacers and has a good display quality.

In the above-described liquid crystal display device 1, the density of disposition of first spacers SSA, which are disposed in the display section 110, is derived by using parameters different from the parameters with which the density of disposition of second spacers SSB is derived. Thus, the invention is not limited to the case in which the density of disposition of first spacers SSA and the density of disposition of second spacers SSB have the same value.

The present invention is not limited directly to the above-described embodiment. In practice, the structural elements can be modified and embodied without departing from the spirit of the invention. For example, the approximation equation shown in FIG. 4 is derived from individual liquid crystal display devices according to, e.g. the density of disposition of first spacers SSA, and the approximation equation shown in FIG. 4 is not applicable to all liquid crystal display devices.

In addition, in the case shown in FIG. 4, the approximation equation was derived by a general polynomial approximation method, but other methods are applicable to the calculation method of the approximation equation.

Various inventions can be made by properly combining the structural elements disclosed in the embodiment. For example, some structural elements may be omitted from all the structural elements disclosed in the embodiment. Furthermore, structural elements in different embodiments may properly be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a pair of substrates opposed to each other;
a liquid crystal layer held between the pair of substrates;
a display section including a plurality of matrix-arrayed display pixels;
a sealant disposed between the substrates to surround the display section; and
a plurality of spacers disposed in a region where the sealant is disposed,
a density of disposition of the spacers having such a value as to set a thickness of the sealant between the spacers and one of the pair of substrates at a predetermined value.

2. The liquid crystal display device of claim 1, wherein the thickness of the sealant on the spacers is approximated by an equation including the density of disposition of the spacers as a parameter, and
the value of the density of disposition of the spacers is a value which is set by the equation such that the thickness of the sealant on the spacers is set at a predetermined value.

3. The liquid crystal display device of claim 1, wherein a distance in a thickness direction of the liquid crystal display device between a central part of a first substrate, which is one of the pair of substrates, and a part of the first substrate, which is supported by the sealant, is more than or equal to 0 μm and smaller than or equal to 0.8 μm.

4. The liquid crystal display device of claim 1, wherein the density of disposition of the spacers is more than or equal to 0.4% and smaller than or equal to 1.6%.
